(19) United States
(12) Patent Application Publication
(10) Pub. No.: US 2012/0164402 A1
(43) Pub. Date: Jun. 28, 2012

(54) DECORATIVE CONCRETE BLOCK AND METHOD OF MANUFACTURING DECORATIVE CONCRETE BLOCK

(75) Inventors: Hirokazu Murakami, Fukui (JP); Tomoyuki Nishikawa, Fukui (JP)

(73) Assignee: SEIREN CO., LTD., Fukui-shi, Fukui (JP)

(21) Appl. No.: 13/394,223

(22) PCT Filed: Apr. 25, 2011
(86) PCT No.: PCT/JP2011/060055

§ 371 Date: Mar. 5, 2012

(30) Foreign Application Priority Data
Apr. 27, 2010 (JP) 2010-101704

(51) Int. Cl. B32B 3/10; B41F 17/24; B32B 13/00

(52) U.S. Cl. 428/195.1; 347/102

(57) ABSTRACT

A decorative concrete block includes a concrete block body having at least one outer surface with an image formed using a plurality of ink dots, the ink dots being obtained by curing ink droplets of an active energy curable ink.

### RELATED APPLICATIONS

The present application is a National Phase of International Application Number PCT/JP2011/060055, filed Apr. 25, 2011, and claims priority from, Japanese Application Number 2010-101704, filed Apr. 27, 2010.

### TECHNICAL FIELD

The present invention relates to a decorative concrete block having an image formed on an outer surface of a concrete block body, and a method of manufacturing the decorative concrete block.

### BACKGROUND ART

A technique relating to a block made of concrete with an image formed on an outer surface has been proposed so far (e.g., refer to Patent Documents 1 and 2). A decorative concrete molding disclosed in Patent Document 1 includes a base material made of concrete, and a decorative surface layer having characters, symbols, designs, patterns, or the like integrally formed on the surface of the base material by baking. In a manufacturing method of the decorative concrete molding disclosed in Patent Document 1, the following steps are performed sequentially. The steps include: the step of pouring a cement-kneaded material, which is obtained by mixing cement, water, aggregate, admixture, and the like, into a desired mold and subjecting the material to vibration and compression to obtain a primary molding; the step of removing internal gas by heating the molding; the step of applying a glaze to the surface of the molding; the step of printing an image on the surface of the dried molding by an inkjet printer apparatus using a slurry decoration material mainly made of a glaze, a pigment, and an oil; and the step of baking the molding. Patent Document 1 illustrates an interlocking block as an exemplary concrete molding.

Patent Document 2 discloses a method of manufacturing a color-patterned concrete block. In this manufacturing method, a material is continuously or intermittently dropped so as to be piled up when the material is loaded into a rapid stripping mold for concrete block molding, or into a movable hopper for carrying the material into the mold per time. The material to be piled is colored at a position to be patterned by blasting or spraying an appropriate amount of pigment an appropriate time. As a result, a colored pattern is formed on the surface of the decorative block product.
Patent Document 1: JP-A-2000-327455
Patent Document 2: JP-A-9-19915

### DISCLOSURE OF THE INVENTION

### Problems to be Solved by the Invention

Incidentally, inkjet printing is widely used as a method for forming a given image. The inkjet printing has an advantage in that suitable images are printable at a high speed. A concrete block body has a liquid absorbing property. Thus, when an image is to be formed on the outer surface of the block body by discharging a solvent- or water-based ink from an inkjet printing apparatus, the block body absorbs the ink landed on the outer surface of the block body. Therefore, it has been difficult to form a suitable image on the outer surface of the block body.

In cases where the decorative concrete block is used outdoors, the appearance of the outer surface of the block body with an image formed using paint or ink may be impaired by contaminants. Generally, contaminants include dust combined with oil components, such as soot and smoke. If the contaminants enter the irregularities on the outer surface of the block body, stain is hardly removed. The outer surface having an image formed thereon can be covered and protected with a topcoat. However, this increases the number of steps. An increase in the number of steps may lead to an increase in cost.

The present invention has an object to provide a new decorative concrete block having an image of a suitable quality formed on an outer surface of a concrete block body, and a method of manufacturing the decorative concrete block.

### Solutions To The Problems

According to an aspect of the present invention, a decorative concrete block includes a concrete block body having at least one outer surface with an image formed using a plurality of ink dots, the ink dots being obtained by curing ink droplets of an active energy curable ink. According to this decorative concrete block, absorption of ink droplets into the concrete block body can be suppressed. That is, the use of an active energy curable ink allows ink droplets of the active energy curable ink to be landed on at least one outer surface of the concrete block body, and allows the ink droplets to suitably adhere to the outer surface. Therefore, a decorative concrete block having an image of a suitable quality formed on an outer surface of a concrete block body can be obtained.

The block body of the decorative concrete block may be any of various concrete blocks for construction. For example, the block body may be a concrete block for construction provided in JIS A5406: 2005. Alternatively, the block body may be a plate-shaped concrete block. A plate-shaped concrete block is, for example, a concrete block for construction provided in JIS A5406: 2005. This block is a block having no web but having a shape formed using one face shell. Alternatively, the block body may be an interlocking block.

This decorative concrete block may be configured as follows. That is, the diameters of the respective ink dots that form the image may be smaller than an opening width of an opening of a vacancy formed within an area of the outer surface where the image is formed. This structure allows the ink droplets to be landed on the inner surface of the vacancy formed in the outer surface of the block body, and allows the ink dots to be formed. Note that the term “a vacancy formed within the area of the outer surface where the image is formed” refers to a recessed vacancy formed during the manufacturing of a block body due to the shape and the like of the materials forming the block body. This vacancy is not a recessed vacancy formed as a design element.

The outer surface of the decorative concrete block may be a bare concrete surface. The image may be directly formed on the bare concrete surface. This simplifies the structure of the decorative concrete block. That is, the use of an active energy curable ink suppresses absorption of ink droplets into the block body. Therefore, a primary coat for forming a suitable image can be eliminated.

The a cured film may be formed using the ink dots that forms the image and obtained by curing ink droplets of an active energy curable ink; and the cure film may have non-adhesive properties based on the provisions of JIS K5600-3-6.6. Such a non-adhesive cured film allows the formation of an image with lower contamination and better weatherability on a decorative concrete block without performing any special process, such as top coating, on a block body.

According to another aspect of the present invention, a method of manufacturing a decorative concrete block having an image formed on at least one outer surface of a concrete block body includes the steps of: forming an image on the outer surface by discharging an active energy curable ink and allowing ink droplets of the active energy curable ink to be landed on the outer surface to form the image by ink dots formed using the ink droplets landed; and after the step of forming the image, irradiating an active energy ray onto the ink droplets that are landed on the outer surface to form the ink dots.

According to this manufacturing method, a decorative concrete block with better functions as described above can be manufactured. The use of the active energy curable ink suppresses absorption of ink droplets into the block body. Thus, the amount of ink to be used for forming an image can be reduced. Therefore, a method of manufacturing a decorative concrete block having an image of a suitable quality formed on an outer surface of a concrete block body can be obtained.

This manufacturing method may be configured as follows. That is, the outer surface may be a bare concrete surface. The image may be directly formed on the bare concrete surface. This can simplify the structure of the decorative concrete block. That is, the use of the active energy curable ink suppresses absorption of ink droplets into the block body. Therefore, a primary coat for forming a suitable image may be eliminated.

In the image-forming step, the active energy curable ink may be discharged such that a cured film formed using the active energy curable ink may have non-adhesive properties based on the provisions of JIS K5600-3-6. According to this structure, a decorative concrete block having an image with lower contamination and better weatherability formed thereon can be manufactured without performing any special process, such as top coating, on the block body.

### BRIEF DESCRIPTION OF THE DRAWINGS

FIG. 1 is a diagram of a decorative concrete block.

FIG. 2 is a photograph of a face shell outer surface of a block body of the decorative concrete block.

FIG. 3 is an enlarged view of a portion “M” shown in FIG. 1, and is also an explanatory diagram of the relationship between the diameter of ink dots and the opening width of an opening of a vacancy formed in the face shell outer surface of the block body of the decorative concrete block.

FIG. 4A is a plan view of a line-type inkjet printing apparatus.

FIG. 4B is a front view of the line-type inkjet printing apparatus.

### DESCRIPTION OF EMBODIMENTS

Embodiments for carrying out the present invention are described with reference to the drawings. The present invention is not limited to the structures described below. According to the present invention, various structures can be adopted based on the same technical idea. For example, part of the structures described below may be omitted or replaced with other structures. The present invention may include other structures.

### <Decorative Concrete Block>

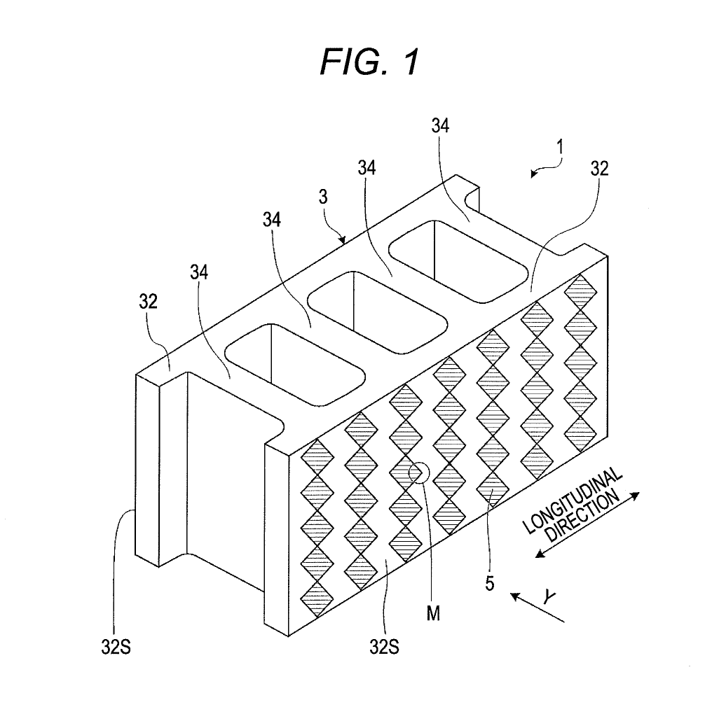

A decorative concrete block 1 of this embodiment is described with reference to FIGS. 1 to 3. The decorative concrete block 1 is a concrete block having a given image formed on an outer surface of a block body 3 made of concrete. For example, an image having a rhombic lattice pattern is formed on an outer surface of a face shell 32 (hereinafter referred to as “face shell outer surface 32S”) that forms a side surface of the block body 3 of the decorative concrete block 1.

The decorative concrete block 1 of this embodiment is formable not only by the block body 3 having a shape as depicted in FIG. 1, but also by various concrete blocks used for construction. For example, the decorative concrete block 1 may be prepared using a plate-shaped concrete block having no web 34 and formed using a single face shell 32. Alternatively, the decorative concrete block 1 may be formed using the interlocking block as described above. The block body 3 depicted in FIG. 1 is a concrete block for construction provided in JIS A5406: 2005. In this embodiment, the block body 3 as depicted in FIG. 1 is described by way of example.

The block body 3 includes a pair of parallel-opposed face shells 32 and a plurality of webs 34. The face shells 32 have an elongated shape (i.e., a rectangular shape) in the longitudinal direction in side view (see arrow “Y” in FIG. 1). The webs 34 are arranged in parallel in the longitudinal direction. The webs 34 are integrally formed with the pair of face shells 32.

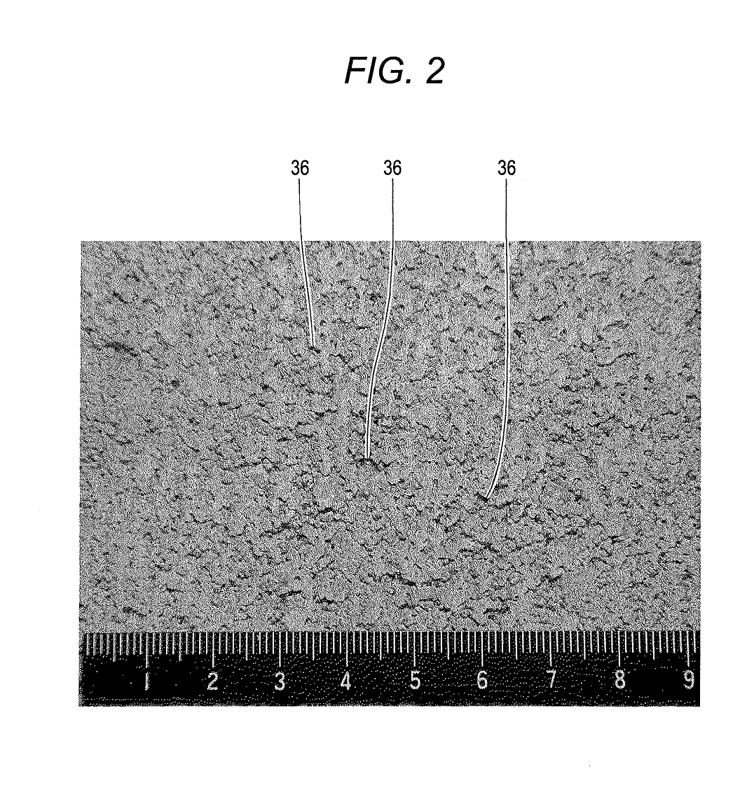

Incidentally, in molding the block body 3, a mixture of cement, aggregate, water, and admixture is molded into a shape as depicted in FIG. 1. Thus, a plurality of recessed vacancies 36 is formed in the outer surfaces of the block body 3 including the face shell outer surface 32S on which an image is to be formed. Specifically, the plurality of recessed vacancies 36 is formed in an area of the face shell outer surface 32S in which an image is to be formed. As depicted in FIG. 2, the vacancies 36 have different shapes and sizes, respectively. Note that the vacancies of this embodiment are recessed vacancies to be formed in manufacturing the block body 3 due to the shape and other factors of the material that forms the block body 3. In other words, the vacancies 36 of this embodiment do not include recessed vacancies formed in the face shell outer surface 32S as a design element.

The admixture is a material to be mixed into concrete for the purpose of, for example, improvement of workability, improvement in strength and durability, and adjustment of a condensation rate. Specifically, examples of the admixture include an AE agent, an AE water-reducing agent, a water-reducing agent, a high-range AE water-reducing agent, fluidization agent, a segregation reducing agent, a foaming agent, an expanding agent, a setting/curing agent, an accelerator, a rust-proof agent, a waterproof agent, ultra-fine particles, polymers for cement admixture, and an expansive agent.

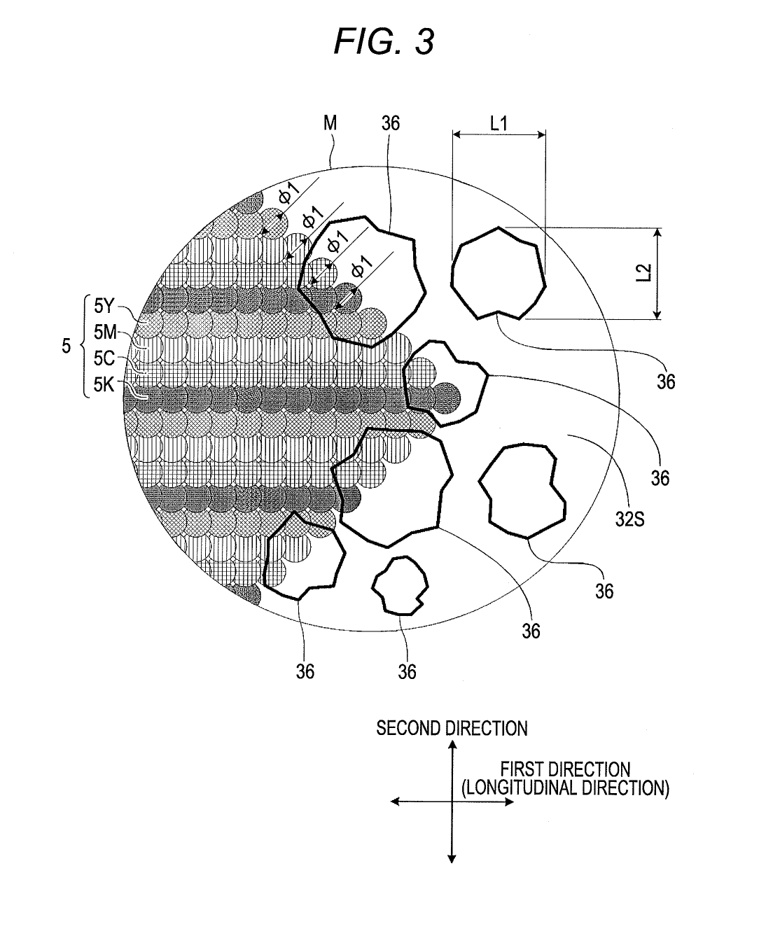

At this time, three types of block bodies 3 (including concrete blocks for construction having shapes different from the shape of the block body 3 depicted in FIG. 1) which are generally available were used as samples, and the vacancies 36 of each sample were observed to measure the shapes. As a result, in the face shell outer surface 32S, the vacancies 36 were formed at a frequency of 4/cm² to 60/cm². As for the shapes of the vacancies 36, opening widths L1 and L2 (see FIG. 3; the larger one of the opening widths L1 and L2 is referred to as “opening width L”) of openings of the vacancies 36 were 0.25 mm to 2.0 mm, respectively. Similarly, the depths of the vacancies 36 were 0.4 mm to 4.0 mm, respectively. As is apparent from this result, the block body 3 of the decorative concrete block 1 includes the face shell outer surface 32S in which the vacancies 36 having the opening width L of the opening of 0.25 mm to 2.0 mm and the depth of 0.4 mm to 4.0 mm were formed at an occurrence rate of 4/cm² or more. Note that the opening width L1 of the opening of each vacancy 36 is a maximum width in a first direction. The opening width L2 is a maximum width in a second direction orthogonal to the first direction. The first direction in this embodiment corresponds to the longitudinal direction of the block body 3 (decorative concrete block 1).

In the decorative concrete block 1, a plurality of ink dots 5 is printed on the face shell outer surface 32S of the block body 3. Thus, an image is formed (printed) on the face shell outer surface 32S. Specifically, the plurality of ink dots 5 is directly printed on the bare concrete surface of the face shells 32. As a result, an image is formed. A plurality of decorative concrete blocks 1 is stacked, for example, to form a block wall or the like of a given size. In this case, the face shell outer surface 32S on which the ink dots 5 are printed serves as a wall surface of the block wall or the like. That is, the wall surface is patterned with the image formed on the face shell outer surface 32S.

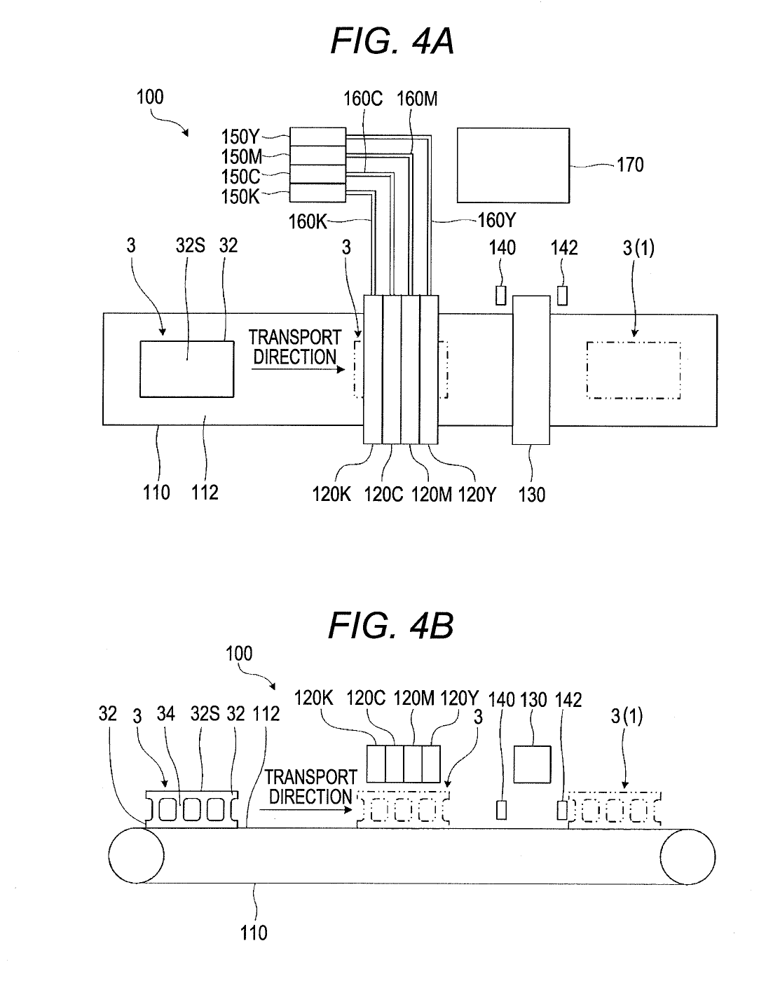

An inkjet printing system is employed to print the ink dots 5. An inkjet printing apparatus for inkjet printing is not particularly limited. For example, a continuous-type inkjet printing apparatus such as a charge modulation system, a microdot system, a charge injection control system, or an ink mist system may be used. Additionally, an on-demand type inkjet printing apparatus such as a piezoelectric system, a pulse jet system, a bubble jet (registered trademark) system, or an electrostatic absorbing system may be used. More specifically, the inkjet printing apparatus may be of, for example, a line-type or a serial-type. In this embodiment, for example, a line-type inkjet printing apparatus 100 as depicted in FIGS. 4A and 4B is used. A method of manufacturing the decorative concrete block 1 using the line-type inkjet printing apparatus 100 is described later. A serial-type inkjet printing apparatus may also be used.

The ink dots 5 are ink droplets cured after landing on the face shell outer surface 32S (the bare concrete surface of the face shell 32). These ink droplets are discharged from the inkjet printing apparatus 100 based on data. Here, the data represents a given image (pattern) and is inputted to the inkjet printing apparatus 100 from an external apparatus, which are communicatably connected to each other. The image formation employs a UV curable ink, which is one type of active energy curable ink. For example, when the colors of UV curable inks used in the image formation are yellow (Y), magenta (M), cyan (C), and black (K), the image is formed using yellow dots 5Y, magenta dots 5M, cyan dots 5C, and black dots 5K. In this embodiment, the term “ink dots 5” is a generic term for the yellow dots 5Y, the magenta dots 5M, the cyan dots 5C, and the black dots 5K.

The relationship between the diameter φ1 of ink dots 5 and the opening width L of the openings of the vacancies 36 is described with reference to FIG. 3. FIG. 3 illustrates the ink dots 5 which are enlarged with respect to the vacancies 36 for convenience of description. In FIG. 3, solid lines representing the outer edges of the openings of the vacancies 36 are depicted on the ink dots 5 in a portion in which the ink dots 5 and the vacancies 36 overlap each other. This allows clear visual recognition of the size differences between the ink dots 5 and the vacancies 36 having openings with the opening widths L1 and L2.

First, the diameter φ1 of the ink dots 5 (a landing diameter of each landed ink droplet) is described. In this embodiment, the resolution of the image formed on the face shell outer surface 32S is set to 2500 dpi to 90 dpi. In this case, the diameters φ1 of the ink dots 5 having a circular shape are about 15 μm to 500 μm. More specifically, when the resolution is set to 360 dpi, for example, the diameters φ1 of the ink dots 5 are about 70 μm to 130 μm (measured values). On the other hand, the opening widths L of the openings of the vacancies 36 formed in the face shell outer surface 32S on which the image is formed are 0.25 mm to 2.0 mm as described above. Therefore, in the decorative concrete block 1 of this embodiment, the diameters φ1 of the ink dots 5 are set to be smaller than the opening widths L of the openings of the vacancies 36 formed in the face shell outer surface 32S. Specifically, the diameters φ1 of the ink dots 5 are set to be smaller than the larger ones of the opening widths L1 and L2 (opening widths L) of the openings of the vacancies 36 formed in the face shell outer surface 32S. The diameters φ1 of the ink dots 5 are set to be smaller than the depths of the openings of the vacancies 36 formed in the face shell outer surface 32S, which has dimensions as described above, as in the case of the opening widths L. Note that in this embodiment, the diameter φ1 of an ink dot 5 (the landing diameter of a landed ink droplet) is the diameter of a dot formed in a circular shape when a single droplet is landed. The resolution of the image formed on the face shell outer surface 32S in this embodiment is derived on the premise that one droplet forms one pixel.

In the decorative concrete block 1, no additional cover layer other than the ink dots 5 may be formed on the face shell outer surface 32S. For example, formation of a base coat layer, on which ink droplets are landed and the ink dots 5 are printed, on the bare concrete surface may be skipped. Further, formation of a topcoat for covering the ink dots 5 and/or coating for providing an antifouling function may be skipped. Alternatively, however, these layers may be formed.

### <UV Curable Ink>

In this embodiment, as for a UV curable ink, a cured film formed using the UV curable ink has non-adhesive properties based on the provisions of JIS K5600-3-6. When such a UV curable ink is used to form an image, absorption of ink droplets into the block body 3 is suppressed, the irregularities on the face shell outer surface 32S are provided with a smooth, non-adhesive cure film formed as a colored design. Therefore, a suitable image is formed on the face shell outer surface 32S of the decorative concrete block 1. In the decorative concrete block 1, stain hardly adheres to the irregularities on the surface. Even if stain adheres to the cured film, the stain can be washed out by rain, water, or the like.

To optimally adjust the adhesion of the cured film, selection of a combination of materials of UV curable ink is made so as to appropriately set the additive amount of each material. Principally, the adhesion is adjustable mainly by adjusting the additive amounts of reactive monomer and oligomer.

The UV curable ink of this embodiment includes pigment, a reactive monomer and/or a reactive oligomer, and photopolymerization initiator, and further includes additives or the like as needed. The ink colors are yellow, magenta, cyan, and black as described above. In addition to these colors, other ink colors, such as light yellow, light magenta, light cyan, white, gray, and clear (transparent) color, may be appropriately used. Light yellow, light magenta, and light cyan UV curable inks are light-colored yellow, magenta, and cyan UV curable inks, respectively. A ratio of concentration of the former ink to the latter ink is, for example, 10% to 30%.

The concentration of pigment is preferably 0.5 to 20 parts by weight with respect to 100 parts by weight of UV curable ink. When the pigment concentration of the ink is less than 0.5 parts by weight, coloring is insufficient, which may lead to difficulty in forming an image. When the pigment concentration exceeds 20 parts by weight, an increase in viscosity of the ink may occur and lead to difficulty in handling the ink in forming an image.

The pigment may be an inorganic pigment or an organic pigment. Inorganic pigment is used for black ink. Examples of the inorganic pigment include metal oxides, hydroxides, sulfides, ferrocyanides, chromates, carbonates, silicates, phosphates, carbons (carbon black), and metal powder. Specifically, as yellow inorganic pigment, CI Pigment Yellow 42 and CI Pigment Yellow 184 may be used. As magenta inorganic pigment, CI Pigment Red 101 and CI Pigment Red 102 may be used. As cyan inorganic pigment, CI Pigment Blue 28 and CI Pigment Blue 36 may be used. As black inorganic pigment, CI Pigment Black 7 may be used.

Examples of organic pigment include nitrosos, dyed lakes, azos, phthalocyanines, anthraquinones, perylenes, quinacridones, dioxazines, isoindolines, quinophthalones, azomethines, and pyrrolo-pyrroles. Specifically, as yellow organic pigment, CI Pigment Yellow 120 and CI Pigment Yellow 150 may be used. As magenta organic pigment, CI Pigment Red 122, CI Pigment Red 178, CI Pigment Red 179, CI Pigment Red 202, CI Pigment Red 254, CI Pigment Violet 19 may be used. As cyan organic pigment, CI Pigment Blue 15, CI Pigment Blue 15:1, CI Pigment Blue 15:2, CI Pigment Blue 15:3, CI Pigment Blue 15:4, CI Pigment Blue 15:6, and CI Pigment Blue 16 may be used. The inorganic pigments or organic pigments as described above may be used singly or in combination of a plurality of kinds.

The reactive monomer and reactive oligomer are preferably aliphatic compounds in view of weatherability. The reactive monomer, may be a hexafunctional acrylate such as dipentaerythritol hexaacrylate and their modified products; pentafunctional acrylate such as dipentaerythritol hydroxypenta acrylate; a tetrafunctional acrylate such as pentaditrimethylolpropanetetraacrylate or pentaerythritol tetraacrylate; a trifunctional acrylate such as trimethylolpropane triacrylate, pentaerythritol triacrylate, tris(2-hydroxyethyl) isocyanuratetriacrylate, or glyceryltriacrylate; a difunctional acrylate such as hydroxypivalic acid neopentyl glycol diacrylate, poly(tetramethylene glycol)diacrylate, trimethylolpropane acrylic acid benzoic acid ester, diethylene glycol diacrylate, triethylene glycol diacrylate, tetraethylene glycol diacrylate, polyethylene glycol (200) diacrylate, polyethylene glycol (400) diacrylate, polyethylene glycol (600) diacrylate, neopentyl glycol diacrylate, 1,3-butanediol diacrylate, 1,4-butanediol diacrylate, 1,6-hexanedioldiacrylate, 1,9-nonanedioldiacrylate, dimethylol-tricyclodecanediacrylate, or bisphenol A diacrylate; and a monofunctional acrylate such as caprolactone acrylate, tridecyl acrylate, isodecyl acrylate, isooctyl acrylate, isomyristyl acrylate, isostearyl acrylate, 2-ethylhexyl-diglycol diacrylate, 2-hydroxybutyl acrylate, 2-acryloyloxyethylhexahydrophthalic acid, neopentyl glycol acrylic acid benzoic acid ester, isoamylacrylate, lauryl acrylate, stearyl acrylate, butoxyethyl acrylate, ethoxy-diethylene glycol acrylate, methoxy-triethylene glycol acrylate, methoxy-polyethylene glycol acrylate, methoxydipropylene glycol acrylate, phenoxyethyl acrylate, phenoxy-polyethylene glycol acrylate, nonyl phenol acrylate, tetrahydrofurfuryl acrylate, isobonyl acrylate, 2-hydroxyethyl acrylate, 2-hydroxypropyl acrylate, 2-hydroxy-3-phenoxypropyl acrylate, 2-acryloyloxyethyl-succinate, 2-acroyloxyethyl-phthalate, or 2-acroyloxyethyl-2-hydroxyethyl-phthalate. In particular, difunctional monomers are preferred because of its better toughness and flexibility. Among difunctional monomers, an aliphatic reactive monomer containing hydrocarbon, specifically, for example, 1,6-hexanediol diacrylate, neopentyl glycol diacrylate, 1,3-butanediol diacrylate, 1,4-butanediol diacrylate, or 1,9-nonanediol diacrylate is preferred because of its having hardly yellowing properties.

Additionally, the reactive monomer may be a reactive monomer obtained by adding a functional group of phosphorus, fluorine, ethylene oxide, or propylene oxide to the above-mentioned reactive monomer may be used as a reactive monomer. These reactive monomers may be used singly or in combination of two or more kinds.

The content of reactive monomer is preferably 50 to 85 parts by weight with respect to 100 parts by weight of UV curable ink. When the content of reactive monomer is less than 50 parts by weight, an increase in viscosity of the ink occurs and leads to difficulty in handling the ink in forming an image. When the content of reactive monomer exceeds 85 parts by weight, curing failure may occur due to insufficient contents of other components necessary for curing.

Examples of the reactive oligomer include urethane acrylate, polyester acrylate, epoxy acrylate, silicon acrylate, and polybutadiene acrylate. These can be used singly or in combination of two or more kinds. Particularly, urethane acrylate is preferred because of its better toughness, flexibility, and adhesion. Among urethane acrylates, aliphatic urethane acrylate containing hydrocarbon is more preferred because of its hardly yellowing properties.

The content of reactive oligomer is preferably 1 to 40 parts by weight with respect to 100 parts by weight of UV curable ink, more preferably, 5 to 40 parts by weight, and still more preferably, 10 to 30 parts by weight. If the content of reactive oligomer falls within the range of 1 to 40 parts by weight, a membrane obtained by curing ink droplets is better in toughness, flexibility, and adhesion.

Examples of photopolymerization initiator include benzoins, benzilketals, aminoketones, titanocenes, bisimidazoles, hydroxyketones, and acylphosphine oxides. These can be used singly or in combination of two or more kinds. Particularly, hydroxyketones and acylphosphine oxides are preferred because of its high reactivity and hardly yellowing properties.

The additive amount of the photopolymerization initiator is preferably 1 to 15 parts by weight with respect to 100 parts by weight of UV curable ink, and more preferably, 3 to 10 parts by weight. When the additive amount of the photopolymerization initiator is less than 1 part by weight, there is a possibility that polymerization is incomplete and the membrane is uncured. Even when more than 15 parts by weight of the photopolymerization initiator is added, further improvement in curing ratio and curing rate is hardly expected, and the cost increases.

A dispersant may be added to the UV curable ink as needed for the purpose of dispersing the pigment. Examples of the dispersant include an anionic surface active agent, a cationic surface active agent, a nonionic surface active agent, an amphionic surface active agent, and a polymer dispersant. These may be used singly or in combination of two or more kinds.

Further, an additive such as a radio-sensitizing agent for promoting initiation reaction of a photopolymerization initiator, a heat stabilizer, an antioxidant, an antiseptic agent, an antifoamer, a penetrant, a resin binder, a resin emulsion, an antireduction agent, a leveling agent, a pH adjuster, a pigment derivative, or a polymerization inhibitor may be added to the UV curable ink as needed. Moreover, an ultraviolet ray absorption agent (hereinafter referred to as “UVA”) and a light stabilizer (hereinafter referred to as “HALS”) may be added to the UV curable ink as an additive.

Typical examples of the UVA include benzophenone-based UVA, benzotriazole-based UVA, a hydroxyphenyltriazine-based UVA, oxanilide-based UVA, and cyanoacrylate-based UVA. These may be used singly or in a mixture of two or more kinds. Various types of HALS are proposed. HALSs may also be used singly or in a mixed state. One important point in adding UVA and HALS is an appropriate additive amount. When the additive amount is small, sufficient weatherability is hardly expected. On the other hand, when the additive amount is large, a bleed out may possibly occur in terms of physical properties, and the cost may increase. In this embodiment, a preferred additive amount of UVA is 0.3 to 5 parts by weight with respect to 100 parts by weight of UV curable ink. A preferred additive amount of HALS is also 0.3 to 5 parts by weight.

### <Method of Manufacturing Decorative Concrete Block>

A method of manufacturing the decorative concrete block 1 of this embodiment includes the step of image formation and the step of ultraviolet ray irradiation as an active energy ray irradiation. The method of manufacturing the decorative concrete block 1 is implemented by a line-type inkjet printing apparatus 100 as depicted in, for example, FIGS. 4A and 4B. First, the inkjet printing apparatus 100 is described with reference to FIGS. 4A and 4B. The inkjet printing apparatus 100 includes a transport part 110, printing heads 120K, 120C, 120M, and 120Y, and an ultraviolet ray irradiation part 130. The transport part 110 includes, for example, a conveyor. The transport part 110 transports the block body 3 set on an installation surface 112 from one end side (left end side when FIGS. 4A and 4B are viewed from the front) of the transport part 110 to the other end side (see the block body 3 (decorative concrete block 1) indicated by an two-dot chain line on the right side when FIGS. 4A and 4B are viewed from the front) of the transport part 110. At this time, the block body 3 passes through the printing heads 120K, 120C, 120M, and 120Y and the ultraviolet ray irradiation part 130.

The printing heads 120K, 120C, 120M, and 120Y are arrayed and placed such that the printing heads are adjacent to each other in a direction where the block body 3 is transported by the transport part 110. The printing head 120K is a printing head for discharging a black UV curable ink (UV curable black ink). The printing head 120C is a printing head for discharging a cyan UV curable ink (UV curable cyan ink). The printing head 120M is a printing head for discharging a magenta UV curable ink (UV curable magenta ink). The printing head 120Y is a printing head for discharging a yellow UV curable ink (UV curable yellow ink). Note that the printing heads 120K, 120C, 120M, and 120Y may be arrayed in the order shown in FIGS. 4A and 4B in the transport direction, or may be arrayed in different orders. The order of colors in the array is determined in consideration of various aspects.

Nozzles are formed in the printing heads 120K, 120C, 120M, and 120Y respectively, while facing to the installation surface 112 of the transport part 110. The nozzles form nozzle rows while a plurality of nozzles is arranged in the direction orthogonal to the transport direction. A plurality of nozzle rows is formed in each of the printing heads 120K, 120C, 120M, and 120Y. The UV curable inks corresponding to the respective colors of the printing heads 120K, 120C, 120M, and 120Y are discharged from the corresponding nozzles formed in the printing heads 120K, 120C, 120M, and 120Y.

The ultraviolet ray irradiation part 130 functions as an active energy ray irradiation part. The ultraviolet ray irradiation part 130 is arranged at a given position on the downstream side in the transport direction with respect to the printing heads 120K, 120C, 120M, and 120Y. The ultraviolet ray irradiation part 130 includes an ultraviolet lamp, which is placed to face the installation surface 112 of the transport part 110, and emits an ultraviolet ray as an active energy ray in the direction of the installation surface 112. The ultraviolet ray irradiation part 130 includes a shutter mechanism. Thus, the outgoing ultraviolet ray from the ultraviolet lamp can be prevented from being emitted to the outside by the shutter mechanism. In the ultraviolet ray irradiation part 130, this shutter mechanism is opened or closed to start or stop the irradiation of an ultraviolet ray. Note that the irradiation of an ultraviolet ray may be started and stopped by turning on and off the ultraviolet lamp included in the ultraviolet ray irradiation part 130. In this case, the shutter mechanism can be eliminated.

The irradiation of an ultraviolet ray is carried out, for example, under the conditions where a detection sensor 140 has detected the block body 3. The detection sensor 140 is placed at a given position on the downstream side in the transport direction with respect to the printing head 120Y and the upstream side in the transport direction with respect to the ultraviolet ray irradiation part 130. The initiation of ultraviolet ray irradiation allows the block body 3 to be irradiated with ultraviolet rays. This block body 3 is, before the irradiation, transported by the transport part 110 after being printed with the black dots 5K, the cyan dots 5C, the magenta dots 5M, and the yellow dots 5Y (see FIG. 3) by the recording heads 120K, 120C, 120M, and 120Y. After that, the block body 3 transported by the transport part 110 is further irradiated with an ultraviolet ray. In other words, ink droplets formed using the UV curable ink of each color are landed on the face shell outer surface 32S, which is the bare concrete surface, and the black dots 5K, the cyan dots 5C, the magenta dots 5M, and the yellow dots 5Y are formed. After that, these ink droplets are irradiated with an ultraviolet ray. On the other hand, the ultraviolet ray irradiation is stopped under the condition that a detection sensor 142 has detected that the block body 3 has passed the ultraviolet ray irradiation part 130. The detection sensor 142 is placed at a given position on the downstream side in the transport direction. The ultraviolet ray irradiation may be stopped after a lapse of predetermined hours from the start of the ultraviolet ray irradiation.

Additionally, the inkjet printing apparatus 100 includes, for example, main tanks 150K, 150C, 150M, and 150Y storing black, cyan, magenta, and yellow UV curable inks, respectively, as depicted in FIG. 4A. The UV curable black ink, the UV curable cyan ink, the UV curable magenta ink, and the UV curable yellow ink that are respectively stored in the main tanks 150K, 150C, 150M, and 150Y are supplied to the printing heads 120K, 120C, 120M, and 120Y through ink supply lines 160K, 160C, 160M, and 160Y for the respective colors. As depicted in FIG. 4A, the inkjet printing apparatus 100 includes a control unit 170 for controlling processes executed in the own apparatus. The control unit 170 serves as various functional means. The control unit 170 controls the steps in the method of manufacturing the decorative concrete block 1 to be described later. Note that in FIG. 4B, the main tanks 150K, 150C, 150M, and 150Y, the ink supply lines 160K, 160C, 160M, and 160Y, and the control unit 170, which are depicted in FIG. 4A, are not illustrated.

In the inkjet printing apparatus 100, data representing an image formed on the block body 3 is inputted from an external apparatus. This external apparatus is, for example, a personal computer that is connected to the inkjet printing apparatus 100 so as to be able to communicate with each other. In the inkjet printing apparatus 100, a process such as rasterization is executed on the input data to thereby generate predetermined data. Further, the block body 3 set on the installation surface 112 on one end side of the transport part 110 is transported in the transport direction by the transport part 110. Note that, in FIGS. 4A and 4B, the block body 3 is set on the installation surface 112 such that the longitudinal direction (see FIGS. 1 and 3) of the block body 3 corresponds to the transport direction. The block body 3 is transported in this state. However, the direction in which the block body 3 is set is appropriately set on the basis of various conditions. The block body 3 may be set on the installation surface 112 such that the longitudinal direction of the block body 3 intersects (for example, orthogonal to) the transport direction.

The block body 3 set on the installation surface 112 is transported by the transport part 110. Then, the block body 3 reaches the position of the block body 3. When FIGS. 4A and 4B are viewed from the front, this position is indicated by a two-dot chain line and located at a central portion. In other words, the block body 3 is transported to the position where the surface on which the nozzles of the printing heads 120K, 120C, 120M, and 120Y are formed and the face shell outer surface 32S are opposite each other. At this time, in the inkjet printing apparatus 100, the UV curable black ink, the UV curable cyan ink, the UV curable magenta ink, and the UV curable yellow ink are discharged onto the face shell outer surface 32S based on the predetermined data generated by rasterization, in the arrangement order of the printing heads 120K, 120C, 120M, and 120Y. The discharged droplets of the UV curable ink of each color are directly landed on and adhere to the face shell outer surface 32S that is the bare concrete surface. As a result, the black dots 5K, the cyan dots 5C, the magenta dots 5M, and the yellow dots 5Y are printed on the face shell outer surface 32S. Thus, an image represented by the input data is formed (image-forming step). The sizes of the ink droplets to be discharged are set such that the diameters φ1 of the ink dots 5 are smaller than the opening widths L of the openings of the vacancies 36 formed in the face shell outer surface 32S.

Further, in the inkjet printing apparatus 100, the transport part 110 transports the block body 3 having an image formed thereon toward the ultraviolet ray irradiation part 130. At the timing when the detection sensor 140 detects the block body 3, the irradiation of an ultraviolet ray toward the installation surface 112 side from the ultraviolet ray irradiation part 130 is started. Then, the ultraviolet ray is applied onto the ink droplets formed using the UV curable ink of each color that form each ink dot 5 landed and adhering to the face shell outer surface 32S which is the bare concrete surface (step of ultraviolet ray irradiation). As a result, the ink droplets are cured, and the cured plurality of ink dots 5 forms an image.

The block body 3 having passed through the ultraviolet ray irradiation part 130 and obtained as the decorative concrete block 1 is removed from the installation surface 112 when the block body 3 reaches the position of the block body 3 (decorative concrete block 1) which is indicated by a two-dot chain line and which is on the right side when FIGS. 4A and 4B are viewed from the front. Then, a new block body 3 is set and the steps described above are executed again. Note that when an image is formed, for example, on the other face shell outer surface 32S that is different from the face shell 32 on which the image is formed the other face shell outer surface 32S and the like are set again on the installation surface 112 so as to be opposite the printing heads 120K, 120C, 120M, and 120Y. Then, the steps described above are executed again.

For example, the decorative concrete block 1 serves as a wall such as a block wall as described above. In this case, the whole or part of the outer surface (including the face shell outer surface 32S) of the decorative concrete block 1, which do not face the outer surfaces of the other adjacent decorative concrete block 1 in the state, for example, where a plurality of decorative concrete blocks 1 is piled up, is sequentially set on the installation surface 112 so as to be opposite the printing heads 120K, 120C, 120M, and 120Y. After that, the steps described above are executed again. As a result, when a wall such as a block wall having a given size is formed by stacking the plurality of decorative concrete blocks 1, the whole or part of the wall surface of, for example, the block wall is patterned with an image.

As described above, a serial-type inkjet printing apparatus may also be used in the method of manufacturing the decorative concrete block 1. The outline of the serial-type inkjet printing apparatus is described. The serial-type inkjet printing apparatus includes a carriage having printing heads mounted thereon. In the serial-type inkjet printing apparatus, the carriage is driven to allow the printing heads to perform scanning in a main-scanning direction (carriage-moving direction). Along with this, a base material such as the block body 3 is intermittently transported in a transport direction (sub-scanning direction) orthogonal to the main scanning direction. In this state, an ink such as UV curable ink is discharged to form an image. The printing heads are mounted with tanks storing UV curable inks of colors such as black, yellow, magenta, and cyan, in the same manner as described above. The UV curable inks are supplied to the printing heads corresponding to the respective colors from the tanks corresponding to the respective colors. The printing heads corresponding to the respective colors are provided with a plurality of ink discharge nozzles along both the main scanning and the sub-scanning direction. In the serial-type inkjet printing apparatus, an ultraviolet ray irradiation part may be provided to the carriage mounted with the printing heads.

In the case of using the serial-type inkjet printing apparatus in which the ultraviolet ray irradiation part is provided to the carriage, the step of providing ink droplets onto the face shell outer surface 32S and the step of applying an ultraviolet ray are repeatedly carried out for each main scanning. The step of providing ink droplets corresponds to a step included in the image-forming step described above. The step of applying the ultraviolet ray corresponds to the ultraviolet ray irradiation step described above. The main scanning refers to a movement of the printing heads on the same line. The main scanning includes the following modes in all of which the printing heads are not moved in the sub-scanning direction. That is, the main scanning includes: a mode in which the printing heads are moved once from the left to the right; a mode in which the printing heads are moved a plurality of times from the left to the right; a mode in which the printing heads are move once from the right to the left; a mode in which the printing heads are moved a plurality of times from the right to the left; a mode in which the printing heads reciprocate once; and a mode in which the printing heads reciprocate a plurality of times. The phrase “each main scanning” means that each time the printing heads are moved from one line to another line (each movement in the sub-scanning direction). Therefore, in the serial-type inkjet printing apparatus in which the ultraviolet ray irradiation part is provided to the carriage, ink droplets are cured by the ultraviolet ray irradiation part per main scanning or in parallel with main scanning of the printing heads.

The printing heads of the line-type or serial-type inkjet printing apparatus may be provided with a heating device. This heating device heats a UV curable ink to be discharged. The heated UV curable ink is suitably discharged, because the viscosity of the ink is lowered. The heating temperature is preferably 25° C. to 150° C., and more preferably, 30° C. to 70° C. The heating temperature is determined in consideration of curing properties of a reactive monomer and/or a reactive oligomer with respect to heat. A heating temperature is set to be lower than a temperature at which curing is started by heat.

The applied amount of the UV curable ink for forming an image on the face shell outer surface 32S of the block body 3 is preferably 1 g/m² to 100 g/m², and more preferably, 1 g/m² to 50 g/m². When this applied amount is less than 1 g/m², an image may not be fully represented and that water resistance may deteriorate. When the added amount exceeds 100 g/m², a failure may occur in curing of the UV curable ink.

The thickness of a cured film of the UV curable ink forming the image is preferably 1 μm to 150 nm. When the thickness of the cured film is less than 1 μm, there is a tendency that the image may not be fully represented. On the other hand, when the thickness of the cured film exceeds 150 μm, the cured film is prone to peel off.

As for the ultraviolet ray irradiation conditions for curing a reactive monomer and/or a reactive oligomer included in the UV curable ink, the output of the ultraviolet lamp is preferably 50 W/cm to 280 W/cm, and more preferably, 80 W/cm to 200 W/cm. When the output of the ultraviolet lamp is less than 50 W/cm, the peak intensity and accumulated light quantity of the ultraviolet ray are insufficient, so that the UV curable ink tends to be cured insufficiently. When the output of the ultraviolet lamp exceeds 280 W/cm, the cured film of the UV curable ink tends to deteriorate. Note that the time for irradiation of the ultraviolet ray is preferably 0.1 seconds to 20 seconds, and more preferably, 0.5 seconds to 10 seconds.

### <Evaluation Results of Staining Properties and Weatherability>

The staining properties and weatherability of the decorative concrete block 1 described above were evaluated. This evaluation is described below.

### <Preparation of UV Curable Ink>

### 1. Preparation of Dispersion

Dispersion compositions of each color pigment were mixed at a mixing ratio shown in Table 1. A dispersion liquid was prepared by dispersing the obtained mixture using a bead mill.

TABLE 1

| | | Yellow | Magenta | Cyan | Black |
|---|---|---|---|---|---|
| | | Disper- | Disper- | Disper- | Disper- |
| | Material Name | sion | sion | sion | sion |
| Pigment | TSY-1 | 25 wt % | | | |
| | 160ED | | 25 wt % | | |
| | Blue#9410 | | | 40 wt % | |
| | NIPex35 | | | | 15 wt % |
| Dispersant | SOLSPERSE32000 | | | | 5 wt % |
| | SOLSPERSE36000 | 10 wt % | 10 wt % | 10 wt % | |
| Monomer | SR9003 | 65 wt % | 65 wt % | 50 wt % | 80 wt % |

Details of each material shown in Table 1 are as follows.

TSY-1 (CI Pigment Yellow 42): manufactured by TODA KOGYO CORP.
160ED (CI Pigment Red 101): manufactured by TODA KOGYO CORP.
BLUE#9410 (CI Pigment Blue 28): manufactured by Dainichiseika Color & Chemicals Mfg. Co., Ltd.
NIPex35 (CI Pigment Black 7): manufactured by Evonik Degussa Japan Co., Ltd.
SOLSPERSE32000 (polymer dispersant): manufactured by The Lubrizol Corporation
SOLSPERSE36000 (polymer dispersant): manufactured by The Lubrizol Corporation
SR9003 (PO-modified neopentyl glycol diacrylate, difunctional): Sartomer Japan Inc.

### 2. Preparation of UV Curable Ink

UV curable inks were prepared using dispersions prepared in the above process “1” at a blending ratio shown in Tables 2 and 3. A UV curable yellow ink, a UV curable magenta ink, a UV curable cyan ink, and a UV curable black ink were prepared using a yellow dispersion, a magenta dispersion, a cyan dispersion, and a black dispersion.

The adhesion of a cured film was evaluated as follows. The prepared UV curable inks of the respective colors were applied onto a Galvalume steel plate, on which a polyester resin was coated, in a square shape of 10 cm×10 cm with a film thickness of 20 μm by inkjet printing. After that, an ultraviolet ray was irradiated immediately (a metal halide lamp, an output of 160 W/cm×5 seconds), so that the UV curable inks were cured. Thus, a specimen was prepared. The adhesion was measured using the prepared specimen in compliance with “A” method based on the provisions of JIS K5600-3-6. Tables 2 and 3 show measurement results related to the adhesion of the UV curable inks of each color. Table 2 shows evaluation results for Examples 1 to 3 related to this embodiment. Table 3 shows evaluation results for Comparative Examples 1 to 3 to be compared.

TABLE 2

| | Material Name | Example 1 | Example 2 | Example 3 |
|---|---|---|---|---|
| Dispersion | Various | 16 wt % | 16 wt % | 16 wt % |
| | Dispersions | | | |
| Oligomer | CN963B80 | 15 wt % | | 15 wt % |
| | CN981 | | | |
| | CN966J75 | | | |
| | CN929 | | 15 wt % | |
| Monomer | SR238F | 50 wt % | | 38 wt % |
| | SR9003 | 9 wt % | 8 wt % | 16 wt % |
| | SR247 | | 51 wt % | |
| | SR344 | | | |
| | SR489 | | | 5 wt % |
| | SR285 | | | |
| | IB-XA | | | |
| Initiator | Irgacure184 | 3 wt % | 3 wt % | 3 wt % |
| | Irgacure819 | 3 wt % | 3 wt % | 3 wt % |
| UVA | TINUVIN479 | 2 wt % | 2 wt % | 2 wt % |
| HALS | TINUVIN123 | 2 wt % | 2 wt % | 2 wt % |

| | | | |
|---|---|---|---|
| Yellow Ink Adhesion | Non-adhesive | Non-adhesive | Non-adhesive |
| Magenta Ink Adhesion | Non-adhesive | Non-adhesive | Non-adhesive |
| Cyan Ink Adhesion | Non-adhesive | Non-adhesive | Non-adhesive |
| Black Ink Adhesion | Non-adhesive | Non-adhesive | Non-adhesive |

TABLE 3

| | | Comparative | Comparative | Comparative |
|---|---|---|---|---|
| | Material Name | Example 1 | Example 2 | Example 3 |
| Dispersion | Various | 16 wt % | 16 wt % | 16 wt % |
| | Dispersions | | | |
| Oligomer | CN963B80 | | | 10 wt % |
| | CN981 | 5 wt % | | |
| | CN966J75 | | 10 wt % | |
| | CN929 | | | |
| Monomer | SR238F | | | 3 wt % |
| | SR9003 | | | 3 wt % |
| | SR247 | | | |
| | SR344 | 15 wt % | 10 wt % | |
| | SR489 | 40 wt % | | 58 wt % |
| | SR285 | | 34 wt % | |
| | IB-XA | 14 wt % | 20 wt % | |
| Initiator | Irgacure184 | 3 wt % | 3 wt % | 3 wt % |
| | Irgacure819 | 3 wt % | 3 wt % | 3 wt % |
| UVA | TINUVIN479 | 2 wt % | 2 wt % | 2 wt % |
| HALS | TINUVIN123 | 2 wt % | 2 wt % | 2 wt % |

| | | | |
|---|---|---|---|
| Yellow Ink Adhesion | Adhesive | Adhesive | Adhesive |
| Magenta Ink Adhesion | Adhesive | Adhesive | Adhesive |
| Cyan Ink Adhesion | Adhesive | Adhesive | Adhesive |
| Black Ink Adhesion | Adhesive | Adhesive | Adhesive |

Details of each material shown in Tables 2 and 3 are as follows.

CN963B80 (urethane acrylate oligomer, difunctional): manufactured by Sartomer Japan Inc.
CN981 (urethane acrylate oligomer, difunctional): manufactured by Sartomer Japan Inc.
CN966J75 (urethane acrylate oligomer, difunctional): manufactured by Sartomer Japan Inc.
CN929 (urethane acrylate oligomer, trifunctional): manufactured by Sartomer Japan Inc.
SR238F (1,6-hexanediol diacrylate, difunctional): manufactured by Sartomer Japan Inc.
SR9003 (PO-modified neopentyl glycol diacrylate, difunctional): manufactured by Sartomer Japan Inc.
SR247 (neopentyl glycol diacrylate, difunctional): manufactured by Sartomer Japan Inc.
SR344 (polyethylene glycol 400 diacrylate, difunctional): manufactured by Sartomer Japan Inc.
SR489 (tridecyl acrylate, monofunctional): manufactured by Sartomer Japan Inc.
SR285 (tetrahydrofurfuryl acrylate, monofunctional): manufactured by Sartomer Japan Inc.
IB-XA (isobornyl acrylate, monofunctional): manufactured by KYOEISHA CHEMICAL Co., Ltd.
Irgacure 184 (1-hydroxy-cyclohexyl phenyl ketone, hydroxy ketones): manufactured by BASF Japan Ltd.
Irgacure819 (bis(2,4,6-trimethylbenzoyl)-phenylphosphine oxide, acylphosphine oxides): manufactured by BASF Japan Ltd.

### TINUVIN479

(2-(2hydroxy-4-{1-octyloxycarbonylethoxy}phenyl)-4,6-bis(4-phenylphenyl)-1,3,5-triazine, hydroxyphenyl triazines): manufactured by BASF Japan Ltd.
TINUVIN123 (a reactive product of decanedioic acid,
bis(2,2,6,6-tetramethyl-1-(octyloxy)-4-piperidinyl) ester,
1,1-dimethylethylhydroperoxide, and octane, HALS): manufactured by BASF Japan Ltd.

### <Inkjet Printing Method>

The prepared UV curable yellow ink, UV curable magenta ink, UV curable cyan ink, and UV curable black ink were mounted in the line-type inkjet printing apparatus as depicted in FIG. 4. Next, in this inkjet printing apparatus, a wood-grain pattern image was formed on the face shell outer surface of the block body based on the provisions of JIS A5406: 2005 under the following conditions. Measurement was made of the number of vacancies at given five locations on the face shell outer surface of the block body used for evaluation. The results were 19/cm², 12/cm², 26/cm², 28/cm², and 32/cm², respectively.

The applied amount of the UV curable ink for forming the image was 15 g/m². The film thickness of the cured film of the UV curable ink at this time was 14 μm.

### (Inkjet Printing Conditions)

1) Nozzle diameter: 70 μm
2) Applied voltage: 50 V
3) Pulse width: 20 μs
4) Drive frequency: 3 kHz
5) Resolution: 180 dpi×180 dpi
6) Ink heating temperature: 55° C.

### (Ultraviolet Ray Irradiation Conditions)

1) Lamp type: metal halide lamp

### 2) Output: 160 W/cm

3) Irradiation time: 3 seconds
4) Irradiation distance: 10 cm

### <Evaluation Method>

### A. Staining Properties

Decorative concrete blocks were placed in a 30° C. constant temperature bath and a 50° C. constant temperature zone for one hour, respectively. The decorative concrete blocks taken out from the constant temperature zones at 30° C. and 50° C. were placed on the ground with the face shell outer surface having an image formed thereon as an upper surface. The decorative concrete blocks were placed on the ground such that the face shell outer surface on which an image is formed was leveled. Next, contaminants are applied over the surface at such a degree that the face shell outer surface was covered. The contaminants are a mixture of 50 parts by weight of eight kinds of fine particles (JIS Z8901) for JIS test, and 50 parts by weight of twelve kinds of fine particles (JIS Z8901) for JIS test. After that, the decorative concrete blocks were stood upright so that the face shell outer surface was perpendicular to the ground. Further, water was sprayed over the outer surface with an atomizer to visually evaluate how the stain was removed.

1 . . . Stain was removed by about 80% to 100%
2 . . . Stain was removed by about 60% to 80%
3 . . . Stain was removed by about 40% to 60%
4 . . . Stain was removed by about 20% to 40%
5 . . . Stain was removed by about 0% to 20%

### B. Weathering Test

The decorative concrete blocks were tested using an accelerated weathering test super UV tester. The test conditions are as follows. The presence or absence of peeling of an ink coated film after the test was visually evaluated.

### (Weathering Test Conditions)

1) Light source: water-cooling type metal halide lamp
2) Illuminance: 100 mW/cm²

### 3) Wavelength: 295 nm to 450 nm

4) Temperature: 60° C. (irradiation), 30° C. (condensation)
5) Humidity: 50% (irradiation), 90% (condensation)
6) Cycle: irradiation 5 hours, condensation 5 hours
7) Shower: 10 seconds before and after condensation
8) Test time: 500 hours

### <Evaluation Results>

Table 4 shows evaluation results related to the staining properties and weatherability. The results indicate that the decorative concrete blocks having images formed thereon corresponding to Examples 1 to 3 have better weatherability and are resistant to contamination. In these regards, on the other hand, the results that Comparative Examples 1 to 3 are inferior to Examples 1 to 3 were obtained.

TABLE 4

| | | Example | Example | Example | Comparative | Comparative | Comparative |
|---|---|---|---|---|---|---|---|
| | | 1 | 2 | 3 | Example 1 | Example 2 | Example 3 |
| Stain | 30° C. | 1 | 1 | 1 | 3 | 3 | 3 |
| Properties | 50° C. | 2 | 2 | 2 | 4 | 4 | 4 |
| Weatherability | Peeling | None | None | None | Present | Present | Present |

<Advantageous Effects of this Embodiment>

In the decorative concrete block 1 of this embodiment, UV curable inks were discharged onto the face shell outer surface 32S by using the inkjet printing apparatus 100. Then, an image was formed by the ink dots 5 obtained by allowing the discharged ink droplets to be landed and cured. In this case, the UV curable inks were discharged such that the diameters φ1 of the ink dots 5 are set to be smaller than the opening widths L of the openings of the vacancies 36 formed in the face shell outer surface 32S. This allows the ink droplets to be suitably landed on the face shell outer surface 32S including the inner surfaces of the vacancies 36 and allows the ink droplets to suitably adhere to the face shell outer surface 32S. Then, the ink droplets suitably adhering to the face shell outer surface 32S are irradiated with an ultraviolet ray, thereby allowing the cured ink dots 5 to be printed. That is, an image of suitable quality can be formed on the face shell outer surface 32S of the block body 3 made of concrete.

An image is formed using a UV-curable ink that a cured film formed using the ink has anti-block properties based on the provisions of JIS K5600-3-6. Therefore, the decorative concrete block 1 with good weatherability and anti-contamination property can be formed.

### <Modifications>

The decorative concrete block 1 of this embodiment described above may have the following structure.

(1) The decorative concrete block may be a decorative concrete block including a concrete block body having at least one outer surface with an image formed using a plurality of ink dots, the ink dots being obtained by curing ink droplets of an active energy curable ink, wherein the areas of the respective ink dots that form the image are smaller than an opening area of an opening of a vacancy formed within an area of the outer surface where the image is formed. Also with this structure, the operation and effect similar to those of the decorative concrete block 1 of this embodiment can be obtained.

(2) In the above description, an example has been described in which a UV curable ink is used as an active energy curable ink. Additionally, an electron beam curable ink, which is one type of active energy curable ink, may be used to form an image. Specifically, for example, an electron-beam curable black ink, an electron beam curable cyan ink, an electron beam curable magenta ink, and an electron beam curable yellow ink may be used. In this case, the electron beam curable black ink, the electron beam curable cyan ink, the electron beam curable magenta ink, and the electron beam curable yellow ink are stored in the main tanks 150K, 150C, 150M, and 150Y, respectively, and are supplied to the printing heads 120K, 120C, 120M, and 120Y through the ink supply lines 160K, 160C, 160M, and 160Y, respectively.

In this case, the inkjet printing apparatus 100 includes an electron beam irradiation part serving as an active energy ray irradiation part, in place of the ultraviolet ray irradiation part 130. The electron beam irradiation part is placed so as to face the installation surface 112 of the transport part 110, and an electron beam is applied as an active energy ray in the direction of the installation surface 112. In an electron beam irradiation step as the active energy ray irradiation step, the electron beam from the electron beam irradiation part is applied onto ink droplets formed using the electron beam curable inks of each color which form the respective ink dots 5 and are landed and adhere onto the face shell outer surface 32S (specifically, the face shell outer surface 32S which is the bare concrete surface) of the block body 3. As a result, the ink droplets are cured, and an image is formed by the plurality of cured ink dots 5.

Other features are similar to those of the case of UV curable ink. For example, a cured film formed using the electron beam curable ink has non-adhesive properties based on the provisions of JIS K5600-3-6. Therefore, a description of other features involving the case where the electron beam curable ink is used as the active energy curable ink is given.

1.-7. (canceled)

8. A decorative concrete block comprising:
a block body made of concrete; and
a plurality of ink dots being obtained by curing ink droplets of an active energy curable ink, and forming an image on an outer surface of the block body.

9. The decorative concrete block according to claim 8, wherein
diameters of the respective ink dots that form the image are smaller than an opening width of an opening of a vacancy formed within an area of the outer surface of the block body.

10. The decorative concrete block according to claim 8, wherein
the outer surface is a bare concrete surface, and the image is directly formed on the bare concrete surface.

11. The decorative concrete block according to claim 9, wherein
the outer surface is a bare concrete surface, and the image is directly formed on the bare concrete surface.

12. The decorative concrete block according to claim 8, wherein
the plurality of ink dots forms a cured film, and
the cured film has non-adhesive properties based on the provisions of JIS K5600-3-6.

13. The decorative concrete block according to claim 9, wherein
the plurality of ink dots forms a cured film, and
the cured film has non-adhesive properties based on the provisions of JIS K5600-3-6.

14. The decorative concrete block according to claim 10, wherein
the plurality of ink dots forms a cured film, and
the cured film has non-adhesive properties based on the provisions of JIS K5600-3-6.

15. The decorative concrete block according to claim 11, wherein
the plurality of ink dots forms a cured film, and
the cured film has non-adhesive properties based on the provisions of JIS K5600-3-6.

16. A method of manufacturing a decorative concrete block having an image formed on at least one outer surface of a concrete block body, the method comprising the steps of:
forming an image on the outer surface by discharging an active energy curable ink and allowing ink droplets of the active energy curable ink to be landed on the outer surface to form the image by ink dots formed using the ink droplets landed; and
after the step of forming the image, irradiating an active energy ray onto the ink droplets that are landed on the outer surface to form the ink dots to cure the ink droplets.

17. The manufacturing method according to claim 16, wherein
in the image-forming step, the outer surface is a bare concrete surface, and the image is directly formed on the bare concrete surface.

18. The manufacturing method according to claim 16, wherein
in the image-forming step, the active energy curable ink is discharged such that a cured film formed of the ink dots has non-adhesive properties based on the provisions of JIS K5600-3-6.

19. The manufacturing method according to claim 17, wherein in the image-forming step, the active energy curable ink is discharged such that a cured film formed of the ink dots has non-adhesive properties based on the provisions of JIS K5600-3-6.
